(19) United States
(12) Patent Application Publication
(10) Pub. No.: US 2013/0020290 A1
(43) Pub. Date: Jan. 24, 2013

(54) Supply Line Routing Device

(71) Applicant: TRUMPF Werkzeugmaschinen GmbH + Co. KG, Ditzingen (DE)

(72) Inventor: Peter Epperlein, Ditzingen (DE)

(73) Assignee: TRUMPF WERKZEUGMASCHINEN GMBH + CO. KG, Ditzingen (DE)

(21) Appl. No.: 13/625,475

(22) Filed: Sep. 24, 2012

Related U.S. Application Data
(63) Continuation of application No. PCT/EP2011/053872, filed on Mar. 15, 2011.

(30) Foreign Application Priority Data
Mar. 25, 2010 (DE) 102010003282.4

(51) Int. Cl. F16L 3/015; B23K 26/08

(52) U.S. Cl. 219/121.6; 248/49

(57) ABSTRACT

A supply line routing device is described, for routing supply lines between connection points on components which are movable relative to each other, and having a sheathing with a changeable course. The supply line routing device comprises at least one guide channel for a supply line in the interior of the sheathing; and a plurality of retaining elements disposed in succession in the longitudinal direction of the sheathing on the outside thereof, which are configured to fasten at least one additional supply line to the outside of the sheathing.

### CROSS REFERENCE TO RELATED APPLICATIONS

This application is a continuation of and claims priority under 35 U.S.C. §120 to PCT Application No. PCT/EP2011/053872, filed on Mar. 15, 2011, which claims priority to Germany Application No.10 2010 003 282.4, filed on Mar. 25, 2010. The contents of both of these priority applications are hereby incorporated by reference in their entirety.

### TECHNICAL FIELD

The invention relates to a supply line routing device.

### BACKGROUND

A supply line routing device in the form of an energy guide chain is described in DE 10 2006 005 745 A1. The energy guide chain comprises a support sheathing that is constructed from a plurality of chain links mounted side by side. Adjacent chain links are hinged to each other. By virtue of the articulated connection of the chain links the course of the support sheathing can be changed at least in a plane, so that by altering its course it can respond to position changes of the connection points.

In the interior of the support sheathing there is a cavity running in the longitudinal direction of the support sheathing. The cavity serves as a guide channel for at least one supply line (usually for a bundle of supply lines) which runs in the longitudinal direction of the support sheathing.

Such supply line routing devices are used, for example, on mechanical processing devices, such as laser processing devices. In this case, different supply lines are guided in the interior of the support sheathing. Examples of such supply lines are power cables, gas supply lines, water lines, data transmission cables, etc.

As an example, with the supply line routing device the supply lines are connected starting from a fixed component to a moving component. A typical example for a moving component to which a plurality of supply lines has to be led is the bridge support of a motion unit for a laser processing head. In order to prevent any uncontrolled movements between the connection points of the supply line routing device (which could cause damage or early wear) when the bridge support moves, the supply lines are guided in the interior of a support sheathing of a supply line routing device. Unlike a simple flexible hose, the support sheathing fulfills the functions of supporting and guiding the supply lines. In addition, the support sheathing can also serve to protect the enclosed supply lines against external influences.

Despite the guidance and the protection afforded by the support sheathing, the supply lines may suffer damage or become worn. If an individual supply line is defective, the support sheathing of the assembled supply line routing device is opened and the defective supply line is exchanged. The effort involved in opening the support sheathing, exchanging the supply line, and closing the support sheathing again is considerable. An energy guide chain that has a defective supply line is therefore often exchanged in its entirety, including all supply lines routed therein, which gives rise to relatively high costs, since supply lines in good order are needlessly also exchanged at the same time.

### SUMMARY

In one aspect of the invention, a line routing device is provided comprising a support sheathing with a plurality of retaining elements disposed in succession in the longitudinal direction of the support sheathing. Via the retaining elements, a supply line can be fastened outside the support sheathing. It is possible to choose to lead a supply line that is especially high-maintenance or susceptible to damage outside the support sheathing. In the event of damage this separately guided supply line can be exchanged without time-consuming opening of the support sheathing. The supply line routing device described herein provides advantages in reduced maintenance costs.

In addition, the supply line routing device also has advantages in the assembly of the supply line routing device and the supply lines. In some cases individual supply lines are laid only after the supply line routing device fitted with other supply lines has been connected. Such a case can arise when supply line routing devices fitted with supply lines are sourced as pre-assembled units, and an additional supply line is needed in an individual case. In such a case, the additional supply line can easily be fastened later on to the retaining elements for guidance, without opening the support sheathing.

Particularly well-defined conditions are achieved in an embodiment of the invention in which the retaining elements define a guide track running outside the support sheathing for the supply line to be fastened to the retaining elements.

The supply line routing device is characterized by especially low stress on the separately guided supply line, if via the retaining elements, the guide track is definable in such a way that the guide track runs along the support sheathing and its length remains unchanged when the course of the support sheathing changes. The supply line can consequently be fastened to the retaining elements in such a way that it runs along a “neutral” route (i.e., a neutral axis). Regardless of how the support sheathing is running, due to the position of the connection points of the supply line routing device, the length of the route on which the supply line runs remains unchanged. Accordingly, the supply line is not affected by any tensile or compressive stresses during relative movements of the connection points. The service life of a supply line that is particularly sensitive to tensile or compressive stresses is considerably lengthened because of this measure.

A supply line routing device designed as an energy guide chain has proved successful in practice. In this case, the course of the support sheathing may be changeable owing to the fact that the support sheathing comprises a plurality of chain links disposed in succession in the longitudinal direction of the support sheathing, and adjacent chain links are joined to each other so as to pivot about a pivot axis running transversely to the longitudinal direction of the support sheathing. The result is a robust and inexpensive construction of a supply line routing device. The supporting and guiding function of the support sheathing is determined by the rigid chain links and the defined mobility of the chain links with respect to each other.

The pivot axes around which adjacent chain links are pivotable with respect to each other are typically arranged parallel to each other. The parallel pivot axes produce a supply line routing device which is able to change course only in one movement plane, specifically in a movement plane running perpendicular to the pivot axes. The possibility of course changes within just one movement plane is sufficient in the case of connection points movable relative to one another along only one movement axis or along only one movement plane. In addition, there is the advantage that the supply line routing device is not able to move out of the movement plane in an undesirable manner. Potential collisions with other components can be avoided and/or the installation space required for the supply line routing device can be reduced.

In the case of a supply line routing device having a plurality of chain links connected to each other with a hinge, for geometrical reasons the additional supply line is advantageously guided outside the support sheathing along a neutral route, owing to the fact that a supply line guide track that intersects the pivot axes between adjacent chain links can be defined by the retaining elements.

The retaining elements are typically individually rotatably mounted on the support sheathing. This measure enables each retaining element to move into an optimum rotated position. In addition, owing to the rotatable mounting, if the course of the support sheathing changes the retaining elements are able to perform slight compensating rotational movements, which reduce the stress on the supply line fastened to them. An especially gentle fastening of the supply line is achieved when the axis of rotation of each of the retaining elements coincides with a pivot axis around which two adjacent chain links of the support sheathing are pivotable relative to each other.

The retaining elements can be fastened to the support sheathing by a plug-in connection. Owing to this measure, a pre-assembled supply line routing device can be retrofitted with retaining elements in a simple manner. Because the retaining elements can be detachably fastened to the support sheathing, they can, for example, be exchanged later for different retaining elements.

The retaining elements can be configured in a wide variety of ways. In particular, they can be matched to the particular supply line to be fastened. For example, they can be in the form of two-part retaining rings that enclose the supply line. Other gripping and clamping devices are also possible. Assembly is especially simple and quick if the retaining elements comprise two clip arms into which the supply line merely has to be pushed for fastening.

The supply line routing device can be provided for an automatic laser processing device, wherein for guidance a supply line in the form of a laser light conducting cable is fastened by the retaining elements outside the support sheathing. The arrangement constitutes an especially neat laser beam guiding apparatus with a laser light conducting cable, and is additionally distinguished by a surprisingly simple and inexpensive construction. The advantages of said embodiments of a supply line routing device are especially applicable in the case of an arrangement in which a laser light conducting cable is guided by the retaining elements outside the support sheathing. Laser light conducting cables frequently have to be fastened to pre-assembled supply line routing devices. The support sheathings described herein do not have to be opened up for that purpose. In addition, laser light conducting cables are cables that are especially high-maintenance and susceptible to damage, so that the inventive simple exchange of a defective supply cable where laser light conducting cables are concerned is especially significant. Finally, laser light conducting cables are sensitive to compressive and tensile stresses. Therefore it is advantageous for the service life of a laser light conducting cable if it can be laid along the described neutral route.

An advantageous exemplary embodiment of the invention is explained below with reference to schematic drawings shown in the figures.

### DESCRIPTION OF DRAWINGS

FIG. 1 shows a supply line routing device for a mechanical laser processing device in a first side view.

FIG. 2 shows the supply line routing device from FIG. 1 in a plan view.

FIG. 3 shows the supply line routing device from FIG. 1 in a further side view.

FIG. 4 shows a chain end link of the supply line routing device from FIG. 1 in an end view.

FIG. 5 shows the supply line routing device from FIG. 1 with two different relative positions of connection points between which the supply line routing device runs.

### DETAILED DESCRIPTION

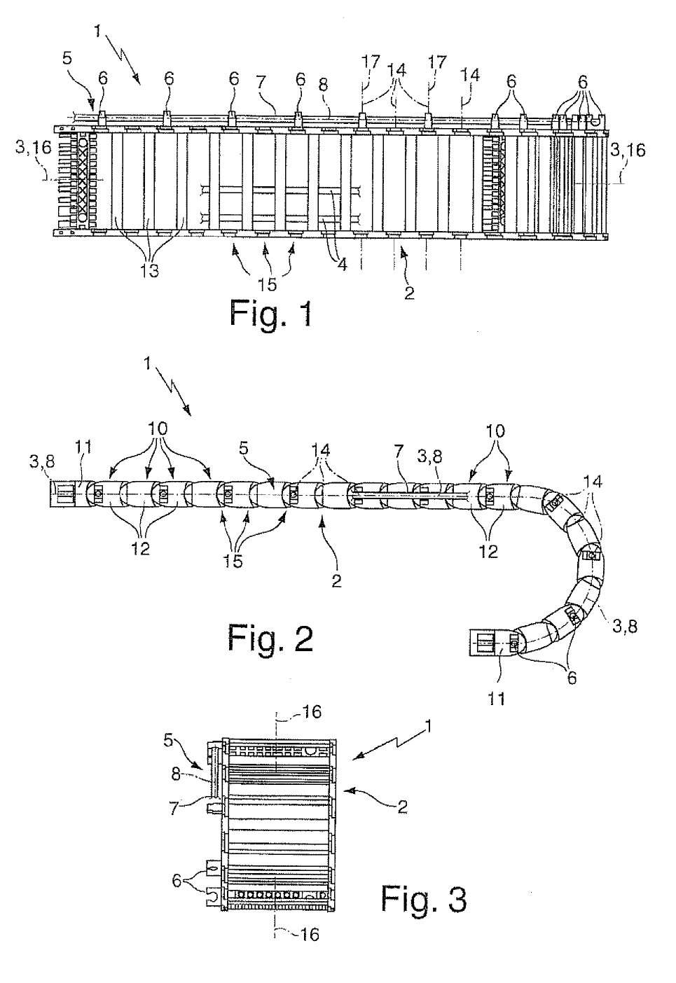

FIG. 1 shows a supply line routing device in the form of an energy guide chain 1 for guiding supply lines between connection points on components of a mechanical processing device that are movable relative to each other. The energy guide chain 1 is intended in particular for use on a laser processing machine.

The energy guide chain 1 comprises a support sheathing 2 with a changeable course. In other words, the sheathing 2 is bendable or articulable. An interior space that runs in the longitudinal direction 3 of the support sheathing 2 is formed inside the support sheathing 2. The interior space serves as a guide channel for a plurality of supply lines. Portions of two of the supply lines 4 enclosed in the support sheathing 2 are indicated in FIG. 1.

The support sheathing 2 has a substantially rectangular cross-section. A plurality of retaining elements 6 disposed in succession in the longitudinal direction 3 of the support sheathing 2 are provided on one narrow longitudinal face 5 of the support sheathing 2. A supply line can be fastened for guidance to the retaining elements 6 outside the support sheathing 2.

On the energy guide chain 1 provided for a laser processing machine, the additional supply line is advantageously a laser light conducting cable 7, only segments of which are indicated in FIGS. 1 to 4. FIGS. 1 to 4 likewise indicate only segments of the course of the guide track 8 of the laser light conducting cable 7. The guide track is defined by the retaining elements 6 outside the support sheathing 2. The guide track 8 describes the course of a middle axis of the laser light conducting cable 7 fastened to the retaining elements 6. In the view of FIG. 2, the line illustrating the guide track 8 is identical at least in segments with the line illustrating the longitudinal direction 3 of the support sheathing 2.

It is particularly apparent from the view shown in FIG. 2 that the support sheathing 2 of the energy guide chain 1 includes a plurality of chain links 10 and two chain end links 11 disposed in succession in the longitudinal direction 3 of the support sheathing 2. Apart from the two chain end links 11, all chain links 10 are of identical construction. Each chain link 10 includes two opposing narrow lateral elements 12 and two opposing elongate support bars 13 (shown in FIG. 1).

Adjacent chain links 10 and end chain links 11 are pivotable relative to one other about a pivot axis 14 (FIG. 1) running transversely to the longitudinal direction 3 of the support sheathing 2. Different designs of pivot joints 15 of the chain links 10, 11 are possible. In the case of the energy guide chain 1, the pivot joints 15 are formed by connecting pins which are pivotally mounted in recesses of an adjacent chain link 10. The pivot axes 14 of all pivot joints 15 run parallel to one another. As a result of this measure, the energy guide chain 1 is able to change its course only within a movement plane 16. In FIG. 1, the movement plane 16 runs perpendicular to the plane of the drawing. The line that is intended to illustrate the course of the movement plane 16 coincides in FIG. 1 with the line illustrating the longitudinal direction 3 of the support sheathing 2. In FIG. 2, the movement plane 16 is parallel to the plane of the drawing. The course of the movement plane 16 is also apparent in the view of FIG. 3. Here too, the movement plane 16 runs perpendicular to the plane of the drawing.

As seen in FIG. 2, the guide track 8 of the laser light conducting cable 7 intersects all pivot axes 14, so that for geometrical reasons the guide track 8 runs along a route whose length remain unchanged (neutral route) despite changes in the course of the support sheathing 2. Owing to this arrangement, the laser light conducting cable 7 that has been laid is not affected by any tensile or compressive stresses arising from changes in the course of the support sheathing 2. The service life of the laser light conducting cable 7 is therefore considerably lengthened.

In the exemplary embodiment shown, the retaining elements 6 are each fastened to a pivot joint 15, e.g., to every other pivot joint 15. The retaining elements 6 are therefore each arranged on a level with a pivot axis 14.

Furthermore, the retaining elements 6 are mounted on the support sheathing 2 so as to be freely rotatable about respective rotational axes 17 that run perpendicular to the narrow longitudinal face 5 of the support sheathing 2. The rotational axes 17 of the retaining elements 6 coincide with respective pivot axes 14. The retaining elements 6 comprise fastening pins, which for fastening the retaining elements 6 to the support sheathing 2 can be pushed into recesses on the support sheathing 2 and are rotatably mounted therein.

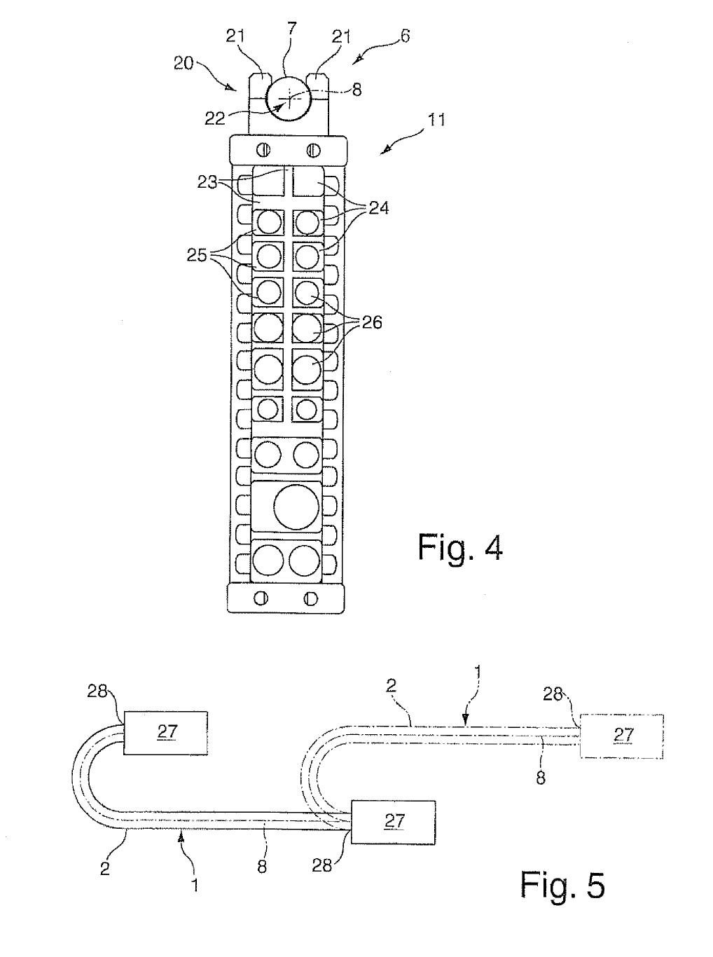

A top part 20 of the retaining elements 6, shown in FIG. 4, comprises two clip arms 21, which form an almost semicircular seat 22 into which the laser light conducting cable 7 merely has to be pushed in order to fasten it to the support sheathing 2.

Moreover, from FIG. 4, which shows a side view of one of the chain end links 11, it is clear that the chain end links 11 have inside them a plurality of transverse and longitudinal dividers 23. These serve to separate different receiving compartments 24. Mounting blocks 25 having cylindrical recesses 26 are inserted in some of the receiving compartments 24. Sockets of the enclosed supply lines 4 can be pushed into the cylindrical recesses 26. The enclosed supply lines 4 are consequently provided at both ends of the energy guide chain 1 with terminals. They are thus connected at the connection points of the energy guide chain 1 also, for example, to further supply lines or consumer units. A pre-assembled energy guide chain arrangement with enclosed supply lines 4 can thus advantageously be provided, and for installation merely needs to be plugged with the end thereof into corresponding terminal arrangements on the components.

In alternative embodiments, the supply lines do not have to terminate at the end of the support sheathing 2, but may be routed onwards after emerging from the support sheathing 2.

Moreover, the supply lines 4 can run loosely in the guide channel formed by the interior space of the support sheathing 2. Alternatively, additional retaining and guiding means for the supply lines 4 can be provided inside the support sheathing 2; these define guide tracks for the supply lines 4 inside the support sheathing 2. It is clear from Figure 4 that the guide tracks, when they run in extension of the various cylindrical recesses 26, run not along a neutral route, but eccentrically.

Because it is possible to guide the laser light conducting cable 7 outside the support sheathing 2, the laser light conducting cable 7 can be fastened in a simple manner to the preassembled energy guide chain 1.

FIG. 5 shows schematically the energy guide chain 1 where components 27 movable relative to each other are in two different positions and the ends of the energy guide chain 1 are fastened to the components 27 at connection points 28. The flexibly cohesive support sheathing 2 of the energy guide chain 1 assumes different courses due to the different positions of its connection points 28. In both of the positions shown, and in all other possible positions, the length of the guide track 8 outside the support sheathing 2 is the same each time.

The energy guide chain 1 is produced from plastics. In this way, a light-weight and inexpensive energy guide chain 1 is obtained. Each of the retaining elements 6 can advantageously be constructed integrally, typically in the form of an injection-molded part that is inexpensive to produce.

In an alternative exemplary embodiment of the invention, a further supply line can be fastened to the energy guide chain 1 by the retaining elements 6. Retaining elements 6 can also be provided on the other narrow longitudinal face of the energy guide chain 1, in order to fasten one or more supply lines.

A number of embodiments of the invention have been described. Nevertheless, it will be understood that various modifications may be made without departing from the spirit and scope of the invention. Accordingly, other embodiments are within the scope of the following claims.

What is claimed is:

1. A supply line routing device for routing supply lines between connection points on components which are movable relative to each other, and having a sheathing with a changeable course, the supply line routing device comprising:
at least one guide channel for a supply line in the interior of the sheathing; and,
a plurality of retaining elements disposed in succession in the longitudinal direction of the sheathing on the outside thereof, which are configured to fasten at least one additional supply line to the outside of the sheathing.

2. The supply line routing device according to claim 1, wherein the supply line routing device is an energy guide chain.

3. The supply line routing device according to claim 1, wherein the retaining elements form a guide track for the additional supply line running outside the sheathing.

4. The supply line routing device according to claim 3, wherein the guide track is defined by the retaining elements in such a way that the guide track runs along the sheathing and the length of the guide track remains unchanged when the course of the sheathing changes.

5. The supply line routing device according to claim 1, wherein the sheathing comprises a plurality of chain links disposed in succession in the longitudinal direction of the sheathing, and adjacent chain links are connected to each other so as to pivot about a respective pivot axis running transversely to the longitudinal direction of the sheathing.

6. The supply line routing device according to claim 5, wherein said pivot axes run parallel to each other.

7. The supply line routing device according to claim 5, wherein the retaining elements define a guide track for an additional supply line and the guide track intersects the pivot axes.

8. The supply line routing device according to claim 1, wherein the retaining elements are rotatably mounted on the sheathing so as to be rotatable about rotational axes of the retaining elements.

9. The supply line routing device according to claim 8, wherein the sheathing comprises a plurality of chain links disposed in succession in the longitudinal direction of the sheathing, and adjacent chain links are connected to each other so as to pivot about a respective pivot axis running transversely to the longitudinal direction of the sheathing, and wherein the rotational axes of the retaining elements coincide with respective pivot axes around which two adjacent chain links of the sheathing are pivotable relative to each other.

10. The supply line routing device according to claim 1, wherein the retaining elements are fastened detachably to the sheathing by a plug-in connection.

11. A laser processing device having a supply line routing device according to claim 1.

12. The laser processing device according to claim 11 having an additional supply line fastened on the outside of the sheathing by the retaining elements.

13. The laser processing device according to claim 12, wherein the additional supply line is in the form of a laser light conducting cable.
